(19) United States
(12) Patent Application Publication
(10) Pub. No.: US 2022/0219420 A1
(43) Pub. Date: Jul. 14, 2022

(54) APPARATUS FOR PROCESSING SOLID WASTE

(71) Applicants: Antonio Carlos Barberena Cava, Porto Alegre (BR); Flavio Roberto de Souza Roscoe, Porto Alegre (BR)

(72) Inventors: Antonio Carlos Barberena Cava, Porto Alegre (BR); Flavio Roberto de Souza Roscoe, Porto Alegre (BR)

(21) Appl. No.: 16/618,956

(22) PCT Filed: Mar. 28, 2019
(86) PCT No.: PCT/BR2019/050104

§ 371 Date: Sep. 3, 2021

(30) Foreign Application Priority Data
Mar. 28, 2018 (BR) BR 202018006320-6

(51) Int. Cl. B30B 9/30; B30B 3/00; B09B 3/32

(52) U.S. Cl. CPC B30B 9/3089; B09B 3/32; B30B 3/00

(57) ABSTRACT

The invention relates to an apparatus for processing solid waste, which comprises a base provided with linear rails (10) on which a carriage (20) moves, said carriage being held on the rails by castors and supported by a hydraulic cylinder; a collection unit arranged at the head end of the rails (10) and provided with an upper opening (30) that receives the waste and transfers it by gravity to a processing unit (40) comprising conical elements (not depicted) in the inner region thereof, and, centrally, a shaft with a helicoid (41) surface, said shaft (41) being rotated by a motor with a motor-reduction unit (42); and an extrusion unit (50) that receives the triturated waste from the collection unit, said extrusion unit (50) comprising a base provided with holes and a conical opening opposite the area of inflow of the waste from the processing unit (40).

The present utility model describes an apparatus for processing solid wastes. More specifically, it comprises an apparatus that triturates and promotes the extrusion of organic and inorganic waste solids, allowing storage in flexible bags.

Human activities generate waste. In recent centuries, the development of modern technologies and the adoption of an economic model based on large-scale production and consumption have increased the production of waste. In addition, the areas available for waste disposal have become scarce and the accumulated dirt has increased the pollution of soil, water and air, in addition to worsening the health conditions of populations.

Waste management is, therefore, a severe problem today. Disposal in dumps, where about 75% waste produced by Brazilian municipalities is sent, favors the spread of diseases through insects and rats, generates an unpleasant smell, and mainly contaminates the soil and water.

More adequate ways can guarantee the correct destination and treatment of waste, such as landfills, composting plants, recycling and reuse and incineration.

One of the alternatives is the storage of waste in packaging, avoiding contact with the external environment. Thus, this waste must be previously triturated and compacted, and then packaged, avoiding any contact by the user with organic or inorganic matter.

The prior art apparatuses have a compaction structure predicting a press. However, there are problems in filling the packaging that holds the waste due to the non-uniform distribution, which causes the deformation of said packaging.

Further, the prior art describes solutions for storing grains in flexible bags, relying on the displacement of the grains through a helicoid, but no means for extrusion of the material are predicted, depending on the characteristics of the material.

Thus, the object of the present utility model is an apparatus for processing solid wastes that predicts the trituration and extrusion of waste in order to reduce the volume and eliminate substantial amounts of liquid, followed by packaging in a flexible bag, avoiding any contact with the external environment or with the apparatus operator, and allowing the packaging of organic and inorganic matter processed in flexible packaging.

In order to better describe the technical characteristics of the apparatus for processing solid wastes, the following related figures are shown:

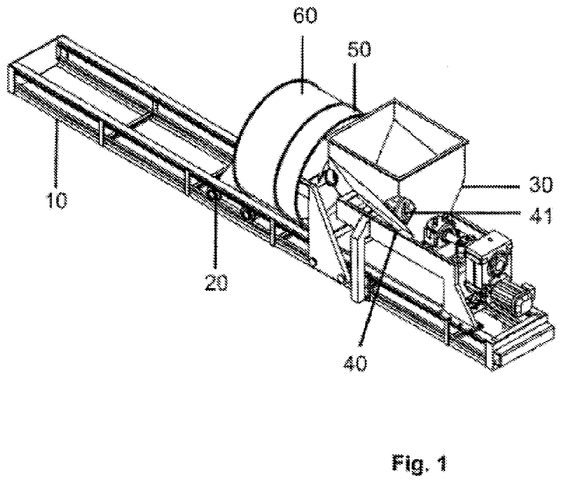

FIG. 1 shows a perspective view.

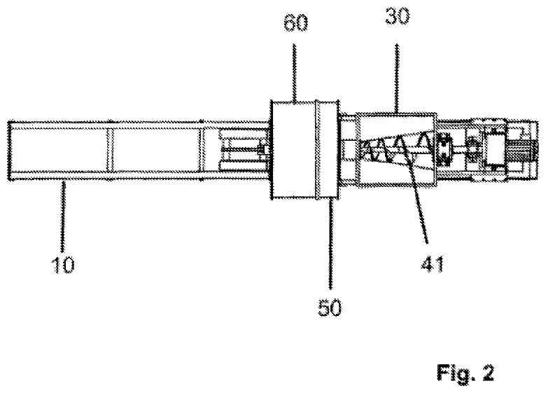

FIG. 2 shows a top view.

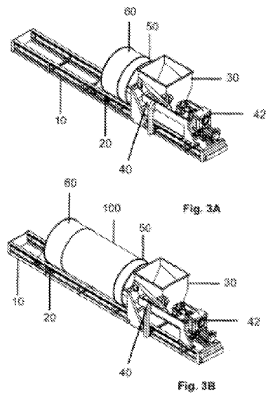

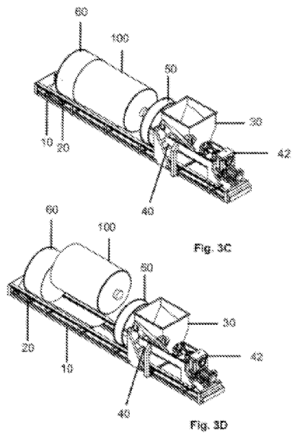

FIG. 3A shows the representation of the flexible bag coupled to the backpressure structure, FIG. 3B shows the beginning of the carriage displacement with the backpressure structure, FIG. 3C shows the representation of the flexible bag being uncoupled from the conical opening of the extrusion unit and the 3D figure shows the displacement of the flexible bag from the guides.

The apparatus for processing solid wastes, object of the present utility model, comprises a unit that provides the trituration and extrusion of organic and inorganic waste solids for storage in a flexible bag.

The apparatus for processing solid wastes has a base provided with linear rails (10) on which a carriage (20) moves, held on the rails by castors and supported by a hydraulic cylinder moves.

At the head end of the rails (10) a collection unit provided with an upper opening (30) is fixed, which receives the waste and forwards it by gravity to a processing unit (40).

The processing unit (40) has conical elements in the inner region (not shown) and centrally a shaft with helicoid (41) surface, said shaft (41) rotated by a motor with motor-reduction unit (42).

The waste is triturated in the processing unit (40) through the rotary movement of the helicoid shaft (41) together with the conical elements (not shown), while said waste is horizontally displaced through the helicoid pitch (41) to the extrusion unit (50).

The extrusion unit (50) has a conical opening opposite the inflow area of the waste coming from the processing unit (40), said conical opening that allows equalizing and uniformly distributing the triturated waste in the flexible bag (100).

The extrusion unit (50) has a base provided with holes for liquid drainage.

On the external surface of the conical opening of the extrusion unit (50) is fixed the end of a flexible bag (100) which is contracted.

On the carriage (20) a back pressure structure (60) is positioned touching the base of the flexible bag (100), said back pressure structure (60) with a hydraulic cylinder controlling the extrusion pressure in order to promote the movement of the movable carriage (20) on the rails (10) of the apparatus base, with the consequent distension of the bag (100).

Thus, as the flexible bag (100) is filled, the back pressure structure (60) moves away from the extrusion unit (50), allowing the total filling of the flexible bag (100), which undergoes distension proportional to its internal filling, as shown in FIGS. 3B and 3C.

Once the volumetric capacity of the flexible bag (100) is filled, the apparatus has its operation interrupted, after which the opening of the bag (100) is sealed and displaced from the guides (10), as shown in the figure. Immediately, a bag (100) is again attached to the conical opening of the extrusion unit (50), and the back pressure structure (60) is then positioned.

Optionally, on the sides of the rails (10) there is a rigid shield (not shown) that surrounds the bag (100) during its filling and supports the pressure, said shield (not shown) being removed when the bag (100) is fully filled.

1. An apparatus for processing solid wastes characterized in that it has:
a base provided with linear rails (10) on which a carriage (20) moves, held on the rails by castors and supported by a hydraulic cylinder;
a collection unit disposed at the head end of the rails (10) and provided with an upper opening (30) that receives the waste and forwards them by gravity to a processing unit (40) having conical elements (not shown) in the inner region and centrally a shaft with helicoid (41) surface, said shaft (41) rotated by a motor-reduction unit (42);
an extrusion unit (50) that receives the triturated waste from the collection unit, said extrusion unit (50) having a base provided with holes and a conical opening opposite to the inflow area of the waste coming from the processing unit (40), with an external surface of the conical opening showing the fixation of a flexible bag (100);
a back pressure structure (60) positioned on the carriage (20) which contacts the base of the flexible bag (100), said back pressure structure (60) with a hydraulic cylinder.

2. The apparatus for processing solid wastes, according to claim 1, characterized in that optionally a rigid shield (not shown) is provided on the sides of the rails (10) to enclose the bag (100) during its filling.
